(19) United States
(12) Patent Application Publication
(10) Pub. No.: US 2002/0096040 A1
(43) Pub. Date: Jul. 25, 2002

(54) Unique phasings and firing sequences for perforating guns

(76) Inventors: James Barker, Mansfield, TX (US); Jerry Walker, Fort Worth, TX (US)

Correspondence Address: CARSTENS, YEE & CAHOON, L.L.P., P.O. Box 802334, Dallas, TX, 75380, US

(21) Appl. No.: 10/097,342

(22) Filed: Mar. 14, 2002

Related U.S. Application Data
(63) Continuation of application No. 09/342,482, filed on Jun. 26, 1999.

(51) Int. Cl. F41F 5/00; B64D 1/04

(52) U.S. Cl. 89/1.15

(57) ABSTRACT

A unique phasing pattern is provided that maximizes the effective perforation geometry of a wellbore. The improvement overcomes the problems associated with multi-phase guns of the past that failed to account for the fact that the gun rested on the low side of the casing. In one embodiment of the present invention, the phasing is arranged so that there is a zero phase tunnel formed. The zero phase tunnel is located at approximately the location where the gun rests against the low side of the well. Further, tunnels are formed by shape charges at plus and minus forty-five degrees and at plus and minus ninety degrees. This can also be referred to as a penta-phase. In another embodiment of the invention, charges can also be placed to allow for a plus and minus one hundred and thirty-five degrees pattern in addition to the penta-phase pattern described above. This expanded pattern can also be referred to as a hepta-phase pattern. By improving the phasing pattern of the perforation gun, valuable hydrocarbon fluids will encounter less resistance to flow into the well.

### BACKGROUND OF THE INVENTION

1. Technical Field of the Invention

This invention relates to an improved perforation gun assembly and its unique phasing of the explosive shape charges to maximize production of oil and/or gas.

2. Description of Related Art

During the completion of a well, it is common to perforate the hydrocarbon containing formation with explosive charges to allow inflow of hydrocarbons to the wellbore. These charges are loaded in a perforation gun and are typically shaped charges that produce an explosive formed penetrating jet in a chosen direction. The effectiveness of the “perforation” is governed by many factors including, but not limited to, the orientation of the gun, the linear spacing and angular arrangement of the explosive charges, the properties of the formation, and the well casing geometry.

Conventional perforating guns come in two primary styles: hollow carrier guns and carrier strip guns. FIG. 1 illustrates a typical hollow carrier gun 10. A plurality of charges 12 are connected to each other by a detonation cord 14. The charges are spaced from each other by a strip 16. Common spacing for such guns is four to six charges 12 per foot. The explosive charges are protected from fluid in the well bore by a housing 18. The housing can be scalloped 20 to enhance charge performance and facilitate gun retrieval. FIG. 2 illustrates a capsule gun carrier strip assembly 24. Carrier strip assembly 24 includes first and second strip members 26 and 28. Strip members 26 and 28 are each elongated members having provisions for retaining shaped charges 30 thereto. Coupling the strip member 26 and 28 together, is a coupling plate 32. A detonation cord 25 connects each of the charges to a detonation energy source. In both figures, the charges are aligned in the same phase. This will produce a single phase of perforation in the formation as shown in FIG. 3.

Referring to FIG. 3, casing 2 is cemented in the well bore 6 by cement 4. During the creation of the well bore, the drilling process can damage a zone around the well. This zone can vary in diameter, but is generally shown by line 8. In this damaged zone, the permeabilty of the formation is particularly diminished. The perforation zone 9 should extend through the casing 2, the cement 4 and through the damaged zone 8 and into the formation 7. When all of the charges are aligned in the same phase, a single perforation phase 9 is formed. This is also called a zero phase perforation. It is well known that while a single phase allows fluid flow into the completed well, it is an incomplete solution. Fluid on the other side of the well from the zone 9 can have difficulty migrating through or around the damaged area and into the zone 9.

One solution is to stagger the shape charges at plus forty-five degrees and minus forty-five degrees from the original zone. FIG. 4 and FIG. 5 illustrate this configuration and the resulting “tri-phase” pattern it produces. The charges are evenly spaced along the carrier strip 52. A first charge 54 is provided with a positive forty-five degree offset. The second charge 56 is provided with no angular offset. The third charge 58 is provided with a minus forty-five degree offset. The fourth charge 60 is provided with no offset, and the final charge illustrated 62 is given a positive forty-five degree angular offset. The tri-phase gun 50 will produce three distinct phases of perforation tunnels 66, 68, and 70. Each tunnel should penetrate through the casing 2, cement 4, and the damage zone 8. A tri-phase pattern helps improve the formation's inflow performance more than a zero phase pattern. Note that the gun 50 is located against one portion of the casing 2 rather than being suspended in the middle. This is true in the field because no well is perfectly vertical. When the gun is suspended into the well, gravity will naturally pull the gun against the low side of the casing.

When considering the phasing and order of angular offset with a tri-phase gun, one design consideration involves the effect of the detonation of the first charge with subsequent charges. In other words, when the first charge 54 detonates, the shock wave from that charge can physically damage or interrupt the second charge 56 as it detonates. The burn rate of the detonation cord 64 is particularly important. While cords burn at extremely fast rates, as the cord lengthens between charges, the more time will pass before the next charges detonates. For a given linear interval between charges, the cord between a charge located at plus forty-five degrees to a charge at zero offset is shorter than a cord between a charge at plus forty-five degrees and a charge at minus forty-five degrees. This is easily understood with reference to FIG. 4. Thus, it is preferable to minimize the cord length between adjacent charges. The order of detonation also is implicated. For example, the gun shown in FIG. 4 detonates charges in a sequence that maintains the shortest fuse length between charges: +45, 0, −45, 0, +45, 0 and so forth.

Another attempt at improving formation production involves the use of a six phase pattern also known as a sixty degree spiral phase gun 80 is loaded with charges, each charge located a sixty degree offset from the previous charge. It will produce a pattern similar to the one shown in FIG. 6. Unfortunately, one result that has been observed is that perhaps only three of the phases will perforate the formation all the way past the damage zone 8. As shown, perhaps only tunnels 82, 84, and 86 penetrate through the damage zone, while tunnels 88, 90, and 92 do not. This is caused by the fact that the gun will rest on the low side of the casing 2. The end result is that if the gun had six charges per foot, only three of the charges per foot had any meaningful impact on the formation. This results in a waste of explosive and a failure to achieve the optimum formation characteristics. Further, larger explosive charges may not be useable because of the limited outer diameter requirements of the gun.

A need exists for an improved method of and assembly for perforating a formation to achieve optimal inflow characteristics by producing novel and non-obvious phasing of the perforations. Such an assembly should minimize the risk of detonation interference from an adjacent charge. Such an assembly should also allow for the maximum number of charges per foot. Finally, the assembly should be able to produce the optimal results without any increase in the outer diameter of the assembly.

### SUMMARY OF THE INVENTION

The present invention relates to an improved phasing of charges in a perforation gun as well as the improved gun that implements that phasing. The improvement overcomes the problems associated with multi-phase guns of the past that failed to account for the fact that the gun rested on the low side of the casing. In one embodiment of the present invention, the phasing is arranged so that there is a zero phase tunnel formed. The zero phase tunnel is located at approximately the location where the gun rests against the low side of the well. Further, tunnels are formed by shape charges at plus and minus forty-five degrees and at plus and minus ninety degrees. This can also be referred to as a penta-phase.

In another embodiment of the invention, charges can also be placed to allow for a plus and minus one hundred and thirty-five degrees pattern in addition to the penta-phase pattern described above. This expanded pattern can also be referred to as a hepta-phase pattern. By improving the phasing pattern of the perforation gun, valuable hydrocarbon fluids will encounter less resistance to flow into the well.

Another aspect of the present invention also relates to the order of detonation of the charges. The present invention minimizes the risk of interference from a previous detonation by minimizing the angular offset between adjacent charges. In other words, each charge in a sequence of charges is separated by a particular angular offset. The offset between adjacent charges is equal to a single multiple of that offset, rather than multiples of that offset.

### BRIEF DESCRIPTION OF THE DRAWINGS

The accompanying drawings are incorporated into and form a part of the specification to provide illustrative examples of the present invention. These drawings together with the description serve to explain the principles of the invention. The drawings are only for purposes of illustrating preferred and alternate embodiments of how the invention can be made and used and are not to be construed as limiting the invention to only the illustrated and described examples. Various advantages and features of the present invention will be apparent from a consideration of the accompanying drawings in which:

FIG. 1 depicts a prior art hollow casing gun;

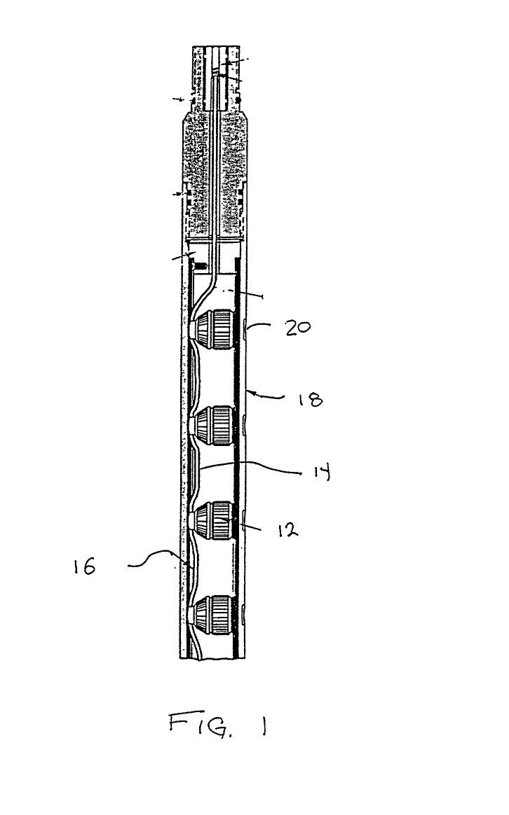

FIG. 2 depicts a prior art carrier strip assembly;

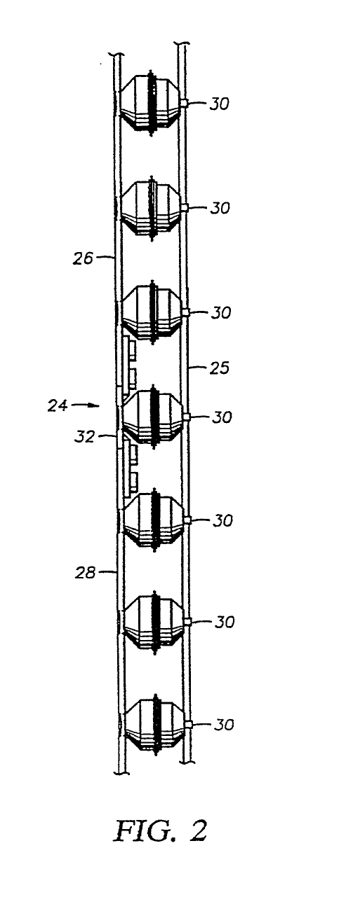

FIG. 3 illustrates a “zero phase” perforation pattern that would be produced by aligned charges on either a hollow casing gun or a carrier strip gun;

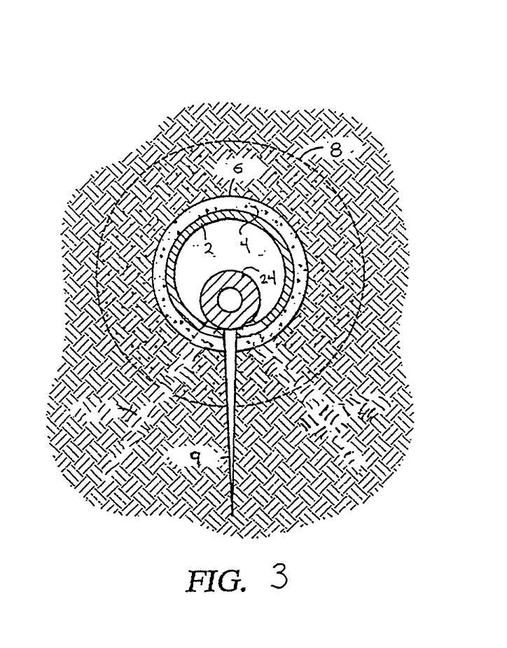

FIG. 4 illustrates a carrier strip loaded for a tri-phase perforation;

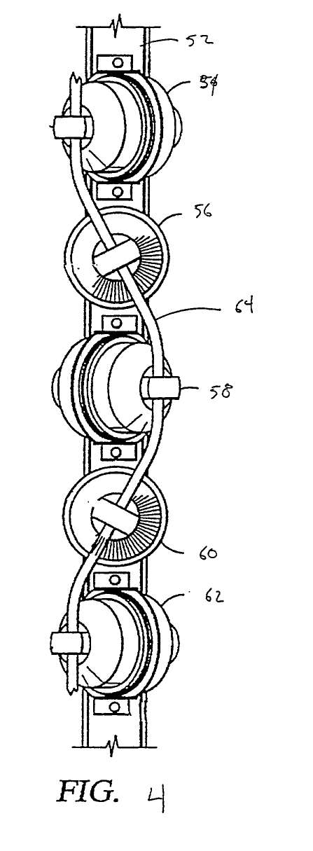

FIG. 5 illustrates a “tri-phase” perforation pattern that would be produced by charges loaded as shown in FIG. 4;

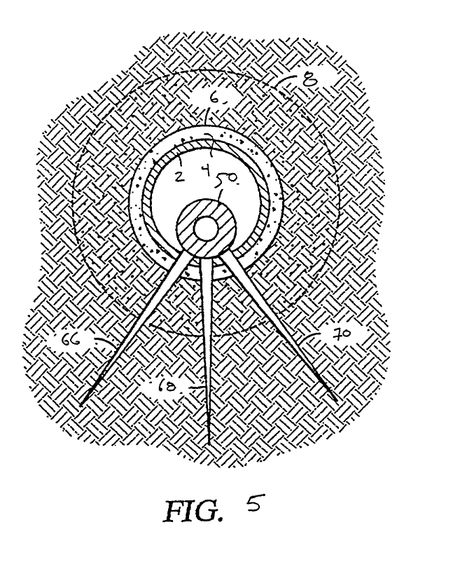

FIG. 6 is a typical spiral phase perforation pattern illustrating a draw back in this phasing pattern;

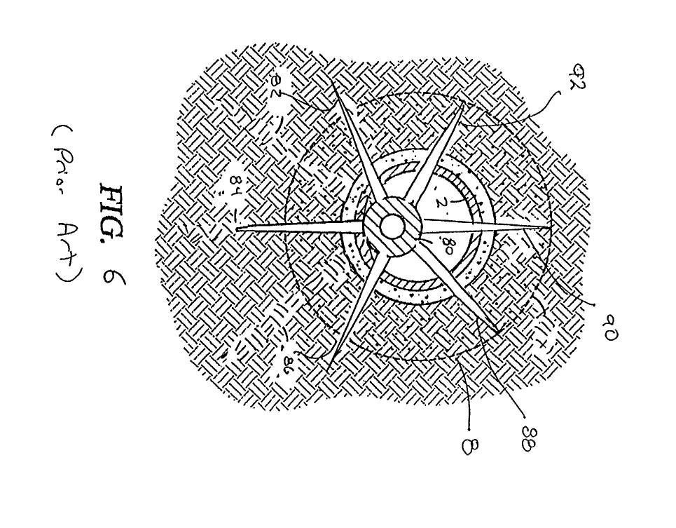

FIG. 7 illustrates a first phasing pattern produced in accordance with the present invention; and

FIG. 8 illustrates a second phasing pattern produced in accordance with the present invention.

### DETAILED DESCRIPTION OF THE DRAWINGS

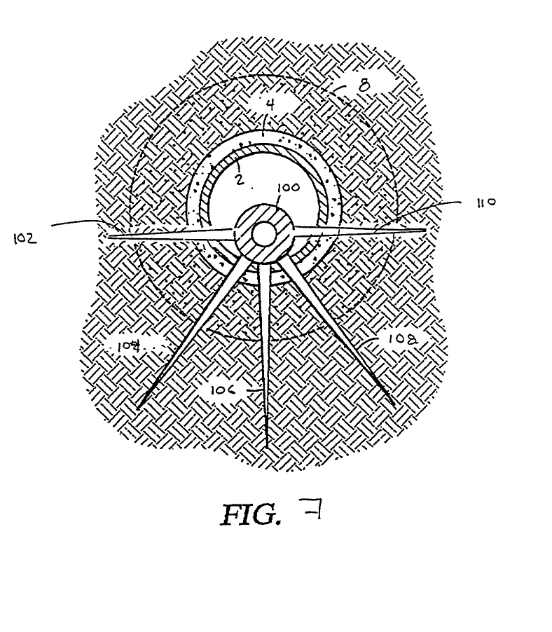

The present invention involves an improved perforation gun and the unique phasing it incorporates. The invention produces superior perforating results because it recognizes that the guns rest on the low side of the casing in the well. Referring to FIG. 7, the perforation pattern produced by a gun 100 embodies the present invention. The gun can be either a hollow carrier gun or a capsule gun as described above. In either case, the perforation pattern is produced by the angular orientation of the shape charges at plus ninety degrees, plus forty-five degrees, zero degrees, minus forty-five degrees, and minus ninety degrees. These charges will produce five phases of perforation tunnels 102, 104, 106, 108 and 110 respectively.

It is assumed that all charges will be of approximately the same strength and produce a tunnel of approximately the same length into the formation. Again, the goal is to penetrate the casing 2, the cement 4 and beyond the damage zone 8. Locating two additional perforations at plus ninety degrees 102 and minus ninety degrees 110 produces two additional perforation phases than the prior art tri-phase pattern and thus improves fluid flow into the well. The present pattern can also be referred to as a low side penta-phase pattern. In the embodiment described above, the fractures are offset by forty-five degrees from each other. However, the pattern could be adjusted to allow for six charges at thirty-degree offsets. Indeed, subject to other limitations, even more fractures could be established at closer intervals. In another embodiment, a first and second tunnel is formed at approximately plus and minus ninety degrees from a zero phase tunnel. Additional tunnels can be spaced between the first and second tunnels and the zero-phase tunnel. While reference is made to specific angular offests, it should be understood that an allowance of some degrees should be allowed when interpreting the meaning of the values given. For example, a positive offset of approximately ninety degrees would easily include positive offsets of one hundred degrees or eighty degrees as well. The value of ninety is merely an exemplary value.

To achieve this pattern, a gun would be loaded with charges set at five different angular orientations. In one embodiment, the order of loading would be plus ninety degrees, plus forty five degrees, zero degrees, minus forty-five degrees, and minus ninety degrees. This pattern minimizes the length of the detonation cord between adjacent charges and thus minimizes the risk of charge-to-charge interference. Other patterns could also be employed subject to the limitations discussed above. The charges would be detonated in a specific sequence of +90, +45, 0, −45, −90, −45, 0, +45 and so forth. This specific firing sequence helps achieve the highest probability that all charges will detonate without interference from an adjacent charge's detonation.

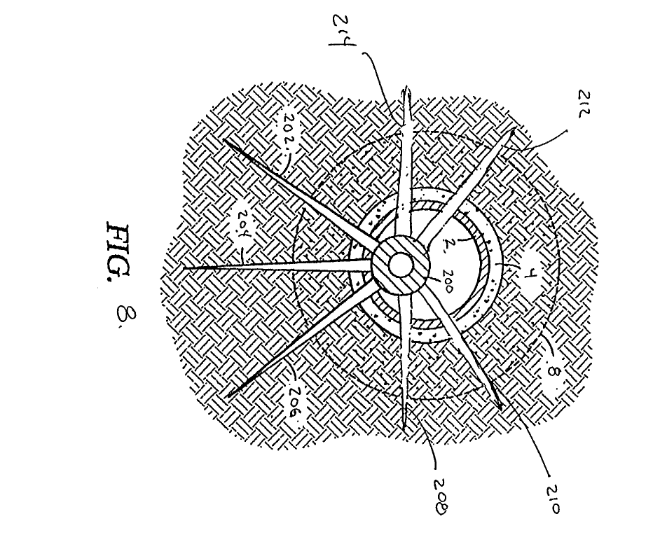

Referring to FIG. 8, a second embodiment of the present invention is illustrated. In this embodiment, two additional perforations are produced at plus one hundred and thirty-five degrees and at minus one hundred and thirty-five degrees. This pattern can also be referred to as a low-side hepta-phase pattern. Seven phases of perforations 212, 214, 202, 204, 206, 208, and 210 are offset from each other by forty-five degrees. Based upon the length of the perforation tunnels and the diameter of the damage zone 8, the additional perforations 212, 210 can still produce a useful penetration into the formation and further enhance fluid migration into the well. A gun 200 designed to produce this pattern can load its charges in any of a number of patterns. In one embodiment, the charges could be loaded at plus one hundred and thirty-five degrees, plus ninety degrees, plus forty-five degrees, zero degrees, minus forty-five degrees, minus ninety degrees, and at minus one hundred and thirty-five degrees. This pattern minimizes the length of the detonation cord between adjacent charges and thus minimizes the risk of charge-to-charge interference. Thus, the firing pattern would be +135, +90, +45, 0, −45, −90, −135, −90, −45, 0, 45, 90 and so forth. Other patterns could also be employed subject to the limitations discussed above.

The embodiments shown and described above are only exemplary. Even though numerous characteristics and advantages of the present inventions have been set forth in the foregoing description, together with the details of the structure and function of the invention, the disclosure is illustrative only, and changes may be made in the detail, especially in the matters of shape, size, and arrangement of parts within the principles of the invention to the full extent indicated by the broad and general meaning of the terms used in the attached claims. It is especially important to note that when angular offsets are provided, the degree of offset is only exemplary. For example, a forty-five degree offset from a zero phase is meant to include any offset that is approximately between thirty and sixty degrees. Each angular offset described, thus, should be given a meaning that includes a substantial variance on either side of the offset.

We claim:

1. A perforation gun comprising:
(a) a plurality of charges arranged on a carrier;
(b) a detonation cord interconnecting said plurality of charges, wherein said charges have an angular offset from a zero phase, wherein a first of said of charges has a positive offset of approximately ninety degrees and a second of said charges has a negative offset of approximately ninety degrees.

2. The perforation gun of claim 1 comprising:
(c) at least two more charges located on the carrier, one having a positive offset of approximately forty-five degrees and another having a negative offset of approximately forty-five degrees.

3. The perforation gun of claim 1 wherein said plurality of charges are arranged at approximately six charges per a one foot length of carrier.

4. The perforation gun of claim 1 wherein said plurality of charges are arranged at approximately four charges per a one foot length of carrier.

5. The perforation gun of claim 1 wherein said plurality of charges are located on a carrier so that a charge has no more than a forty-five degrees offset from an adjacent charge.

6. The perforation gun of claim 1 wherein said plurality of charges are shape charges.

7. The perforation gun of claim 1 wherein said gun is a carrier strip gun.

8. The perforation gun of claim 1 wherein said gun is a hollow carrier gun.

9. The perforation gun of claim 1 wherein said plurality of charges are of equal strength.

10. The perforation gun of claim 1 further comprises:
(c) a third and fourth charge located on said carrier at a positive offset of approximately one hundred and thirty-five degrees and a negative offset of approximately one hundred and thirty-five degrees.

11. A method of perforating a formation comprising the steps of:
(a) lowering a through-tubing perforation gun into the well;
(b) detonating a plurality of charges on said gun so that a plurality of tunnels are formed in the formation; wherein said tunnels include a zero-phase tunnel and a first tunnel at a positive offset of approximately ninety degrees from said zero-phase tunnel and a second tunnel at a negative offset of approximately ninety degrees.

12. The method of claim 11 wherein step (a) further comprises lowering the gun so that it is adjacent to the formation.

13. The method of claim 11 wherein step (b) further comprises forming a tunnel at a positive offset of approximately forty-five degrees and forming another tunnel at a negative offset of approximately forty-five degrees.

14. The method of claim 11 wherein step (b) further comprises detonating a plurality of shape charges.

15. The method of claim 11 wherein step (b) further comprises detonating a plurality of charges, wherein said charges form a plurality of tunnels into the formation past a damage zone.

16. The method of claim 11 further comprises forming a third and fourth tunnel into the formation at a positive offset of approximately one hundred and thirty five degrees and at a negative offset of approximately one hundred and thirty five degrees.

17. The method of claim 11 wherein step (a) comprises lowering a carrier strip gun.

18. The method of claim 11 wherein step (a) comprises lowering a hollow carrier gun.

19. A method of firing a perforation gun comprising the steps of:
(a) initiating a detontation cord that interconnects a plurality of charges loaded on a carrier; wherein said charges have an angular offset from a zero plane;
(b) detonating said charges in a sequential order based on the angular offset of said charge, wherein the sequence of angular offsets is +90, +45, 0, −45, −90, −45, and 0 degrees.

20. The method of claim 19 wherein step (b) further comprises detonating said charges in a sequential order based on the angular offset of said charge, wherein the sequence of angular offsets is +135, +90, +45, 0, −45, −90, −135, −90, −45, 0, +45, +90, and +135 degrees.
